(19) United States
(12) Patent Application Publication
(10) Pub. No.: US 2019/0381993 A1
(43) Pub. Date: Dec. 19, 2019

(54) APPARATUS AND METHOD FOR CONTROLLING MOTOR OF ELECTRIC VEHICLE

(71) Applicant: LG Electronics Inc., Seoul (KR)

(72) Inventors: Jingu PARK, Seoul (KR); Gyujin KIM, Seoul (KR); Manwoo KIM, Seoul (KR); Seunggyu CHOI, Seoul (KR)

(21) Appl. No.: 16/557,732

(22) Filed: Aug. 30, 2019

(30) Foreign Application Priority Data
Aug. 5, 2019 (KR) 10-2019-0095202

(51) Int. Cl. B60W 20/12; B60W 40/072; B60W 40/076; B60W 40/04

(52) U.S. Cl. CPC B60W 20/12; B60W 40/072; G05D 1/021; B60W 40/04; B60W 40/076

(57) ABSTRACT

An apparatus and a method for controlling a motor of an electric vehicle are disclosed. The apparatus receives a driving route for the electric vehicle and divides the driving route into sections. Each of the sections has one of two or more predefined road types. The apparatus calculates a motor control value for each of sections using pieces of past driving-related information of the electric vehicle for each one of the two or more predefined road types, and controls a motor of the electric vehicle based on the calculated motor control value. The electric vehicle may be an autonomous vehicle. In this case, the autonomous vehicle may be operated with an arbitrary artificial intelligence (AI) module, a drone, an unmanned aerial vehicle, a robot, an augmented reality (AR) module, a virtual reality (VR) module, a fifth generation (5G) mobile communication apparatus, or the like.

### CROSS-REFERENCE TO RELATED APPLICATION

This application claims priority to and the benefit of Korean Patent Application No. 10-2019-0095202, filed on Aug. 5, 2019, the disclosure of which is incorporated herein by reference in its entirety.

### BACKGROUND

### 1. Field of the Invention

The present invention relates to an apparatus and method for controlling a motor of an electric vehicle.

### 2. Discussion of Related Art

Electric vehicles are driven by motors which use electrical energy stored in batteries instead of fossil fuel such as gasoline. Accordingly, the electric vehicles are eco-friendly and generate less noise due to discharging less exhaust gas when compared to gasoline or diesel vehicles.

In addition, studies on autonomous vehicles capable of driving autonomously to destinations without operations of drivers are being actively carried out, and autonomous driving is being applied to the electric vehicles.

Meanwhile, in the case of the electric vehicles which drive autonomously, effective use of batteries is important. However, in the case of the conventional technologies, there are no autonomous driving control methods for electric vehicles to improve battery efficiency.

### SUMMARY

The present disclosure is directed to providing an apparatus for controlling a motor of an electric vehicle which improves energy efficiency of the electric vehicle through exact motor control, and a method of controlling the motor.

In addition, the present disclosure is directed to providing an apparatus for controlling a motor of an electric vehicle capable of providing an autonomous driving route according to a user's selection, and a method of controlling the motor.

Objectives of the present disclosure are not limited to the above described objectives, and other objectives, which are not described above, and advantages of the present disclosure may be understood through the following descriptions and clearly understood through embodiments of the present disclosure. In addition, it may be easily seen that the objectives and the advantages of the present disclosure may be realized using the examples and combinations thereof described in the appended claims.

According to an aspect of the present disclosure, there is provided a motor control apparatus comprising an input unit which receives a driving route including a departure location and an arrival location for an electric vehicle, a section dividing unit which divides the expected driving route into a plurality of sections (each of the plurality of sections has one road type of two or more predefined road types), a calculation unit which calculates a motor control value of the electric vehicle for each of the plurality of sections using past driving-related information of the electric vehicle for the two or more predefined road types, and a control unit which controls a motor of the electric vehicle during travel on the driving route based on the calculated motor control value for each of the plurality of sections.

According to another aspect of the present disclosure, there is provided a method of controlling a motor comprising receiving, by an input unit, an expected driving route including a departure location and an arrival location for an electric vehicle, dividing, by a section dividing unit, the driving route into a plurality of sections (each of the plurality of sections includes one of two or more predefined road types), calculating, by a calculation unit, a motor control value of the electric vehicle for each of the plurality of sections using pieces of past driving-related information of the electric vehicle for each one of the two or more predefined road types, and controlling, by a control unit, a motor of the electric vehicle which drives on the received driving route based on the calculated motor control value.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings.

FIG. 1 is a view illustrating an example of a basic operation between an autonomous vehicle and a fifth generation (5G) network within a 5G communication system.

FIG. 2 is a view illustrating an example of an application operation between the autonomous vehicle and the 5G network within the 5G communication system.

FIGS. 3 to 6 are flowcharts for describing example operations of the autonomous vehicle using 5G communication.

FIG. 7 is a schematic view illustrating an example configuration of an electric vehicle.

FIG. 8 is a schematic view illustrating an example motor control apparatus.

FIG. 9 is a view illustrating an example of an expected driving route.

FIG. 10 is a flowchart for describing an example method of generating driving-related information.

FIG. 11 is a table illustrating one example of driving-related information.

FIGS. 12 and 13 are flowcharts for describing example methods of controlling a motor of the electric vehicle.

### DETAILED DESCRIPTION

Hereinafter, embodiments of the present disclosure will be described in detail with reference to the accompanying drawings in order for those skilled in the art to make and use the described technology. The present disclosure may be implemented in several different forms and is not limited to the embodiments described herein.

Parts irrelevant to the description will be omitted, and the same or similar parts are denoted by the same reference numerals throughout this specification. In addition, some embodiments will be described in detail with reference to exemplary drawings. When the reference numerals are assigned to elements of each drawing, and the same elements are illustrated in different drawings, the same reference numerals may be assigned to the same elements if possible. Also, when detailed descriptions of related known configurations or functions are deemed to unnecessarily obscure the gist of the present disclosure, they will be omitted.

In descriptions of components, terms such as “first,” “second,” “A,” “B,” “(a),” and “(b)” can be used. The terms are only to distinguish one element from another element, and essence, order, the number, and the like of the elements are not limited to the terms. It should be understood that, when an element is referred to as being “connected or coupled” to another element, the element may be directly connected or coupled to another element, still another element may be interposed therebetween, or the elements may be connected or coupled by still another element.

In addition, although an element may be subdivided and described for the sake of convenience of description, the subdivided elements may be realized in one device or module, or the subdivided elements may be separately formed in a plurality of devices or modules.

Meanwhile, a vehicle may be an autonomous vehicle capable of driving autonomously to a destination without a user's operation. In this case, the autonomous vehicle may be operated with an arbitrary artificial intelligence (AI) module, a drone, an unmanned aerial vehicle, a robot, an augmented reality (AR) module, a virtual reality (VR) module, a fifth generation (5G) mobile communication apparatus, or the like.

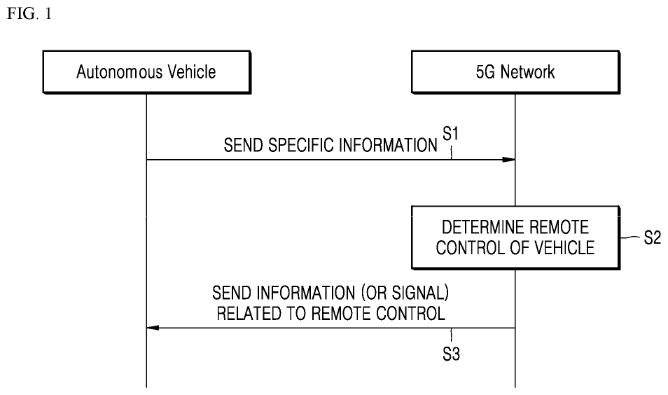

FIG. 1 is a view illustrating an example of a basic operation between an autonomous vehicle and a 5G network within a 5G communication system.

Hereinafter, autonomous driving is a technology of driving autonomously, and an autonomous vehicle is a vehicle which drives without a user's operation or with minimal operations from a user.

For example, the autonomous driving may include a technology of maintaining a driving lane, a technology of automatically adjusting a speed, such as an adaptive cruise control technology, a technology of automatically driving a predetermined route, and a technology of automatically setting a route and driving when a destination is set.

The vehicle may include a vehicle including an internal combustion engine, a hybrid vehicle including both of an internal combustion engine and an electric motor, and an electric vehicle including only an electrical motor, and may include a train, a motorcycle, and the like in addition to a car.

Here, the autonomous vehicle may be a robot having an autonomous driving function.

Hereinafter, one example of a basic communication operation between the autonomous vehicle and the 5G network will be described with reference to FIG. 1. Meanwhile, the autonomous vehicle will be referred to as a “vehicle” for the sake of convenience of description.

The vehicle may send specific information to the 5G network (S1).

The specific information may include autonomous driving-related information.

The autonomous driving-related information may be information directly related to driving control of the vehicle. For example, the autonomous driving-related information may include one or more among object data which indicates objects around the vehicle, map data, vehicle status data, vehicle position data, and driving plan data.

The autonomous driving-related information may further include service information and the like needed for autonomous driving. For example, the specific information may include information of a destination and stability grade of the vehicle which are imported through a user terminal. The 5G network may determine whether the vehicle is remotely controlled (S2).

Here, the 5G network may include a server or module which performs remote control related to autonomous driving.

In addition, the 5G network may send information (or a signal) related to remote control of the vehicle (S3). The information related to the remote control may be a signal directly applied to the vehicle and may further include service information needed for autonomous driving.

According to some embodiments, the vehicle may receive the service information such as information on sectional insurance and risky sections selected from a driving route from the server connected to the 5G network, and may provide a service related to autonomous driving using the information.

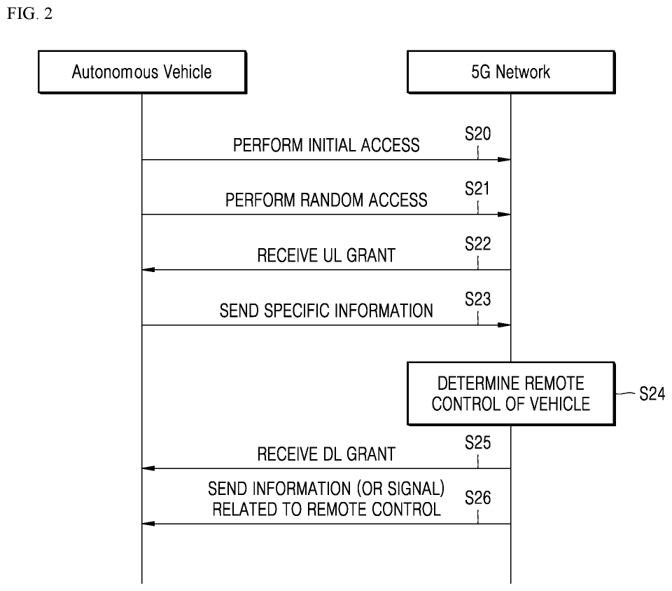

Hereinafter, a required process (for example, an initial access procedure and the like between the autonomous vehicle and the 5G network) for 5G communication between the vehicle and the 5G network to provide an insurance service capable of being applied for each section in an autonomous driving procedure will be schematically described with references to FIGS. 2 to 6.

FIG. 2 is a view illustrating an example of an application operation between an autonomous vehicle and a 5G network within the 5G communication system.

The vehicle may perform an initial access procedure with the 5G network (S20).

The initial access procedure may include a cell search process for acquiring downlink (DL) synchronization, a system information acquisition process, and the like.

The vehicle may perform a random access procedure with the 5G network (S21).

The random access procedure may include a preamble sending process for acquiring uplink (UL) synchronization or sending UL data, a process of receiving a random access acknowledgment, and the like.

The 5G network may send a UL grant for scheduling sending of specific information to the vehicle (S22).

The receiving of the UL grant may include a process of receiving time and frequency resource scheduling in order to send the UL data to the 5G network.

The vehicle may send the specific information to the 5G network based on the UL grant (S23).

The 5G network may determine whether the vehicle is remotely controlled (S24).

The vehicle may receive a DL grant from the 5G network through a physical downlink control channel as an acknowledgment of receiving the specific information (S25).

The 5G network may send information (or a signal) related to remote control to the driving vehicle based on the DL grant (S26).

Meanwhile, in FIG. 2, the example in which the initial access procedure and/or the random access procedure between the autonomous vehicle and the 5G communication network and the DL grant receiving procedure are combined has been described through the operations S20 to S26, but the present disclosure is not limited thereto.

For example, an initial access procedure and/or a random access procedure may be performed through the operations S20, S22, S23, S24, and S26. In addition, an initial access procedure and/or a random access procedure may be performed through the operations S21, S22, S23, S24, and S26. In addition, a process of combining an AI (Artificial Intelligence) operation and a DL grant receiving procedure may be performed through the operations S23, S24, S25, and S26.

In addition, it has been described that a vehicle operation for autonomous driving is controlled through the operations S20 to S26, but the present disclosure is not limited thereto.

For example, the autonomous vehicle may operate through an operation which is selectively combined from among the operations S20, S21, S22, and S25 and the operations S23 and S26. In addition, an operation of the autonomous vehicle may also include the operations S21, S22, S23, and S26. In addition, an operation of the autonomous vehicle may also include the operations S20, S21, S23, and S26. In addition, an operation of the autonomous vehicle may include the operations S22, S23, S24, and S26.

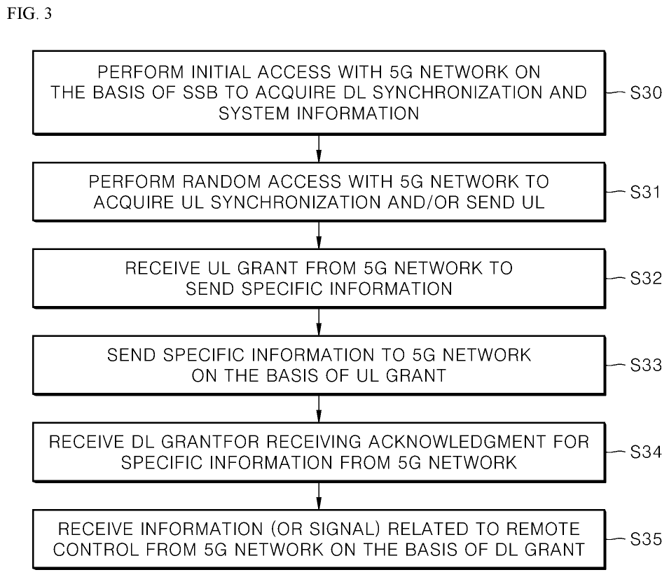

FIGS. 3 to 6 are flowcharts for describing example operations of an autonomous vehicle using 5G communication.

Referring to FIG. 3, the vehicle including an autonomous driving module may perform an initial access procedure with a 5G network based on a synchronization signal block (SSB) so as to acquire DL synchronization and system information (S30).

The vehicle may perform a random access procedure with the 5G network so as to acquire UL synchronization and/or send UL (S31).

The vehicle may receive a UL grant from the 5G network so as to send specific information (S32).

The vehicle may send the specific information to the 5G network based on the UL grant (S33).

The vehicle may receive a DL grant for receiving an acknowledgment for the specific information from the 5G network (S34).

The vehicle may receive information (or a signal) related to remote control from the 5G network based on the DL grant (S35).

The operation S30 may further include a beam management (BM) process. In addition, the operation S31 may further include a beam failure recovery process related to sending physical random access channel (PRACH). In addition, the operation S32 may further include a quantum cascade laser (QCL) relationship with regard to a beam receiving direction of a physical downlink control channel (PDCCH) including the UL grant. In addition, the operation S33 may further include a QCL relationship with regard to a beam sending direction of a physical uplink control channel (PUCCH)/physical uplink shared channel (PUSCH) including the specific information. In addition, the operation S34 may further include a QCL relationship with regard to a beam receiving direction of a PDCCH including the DL grant.

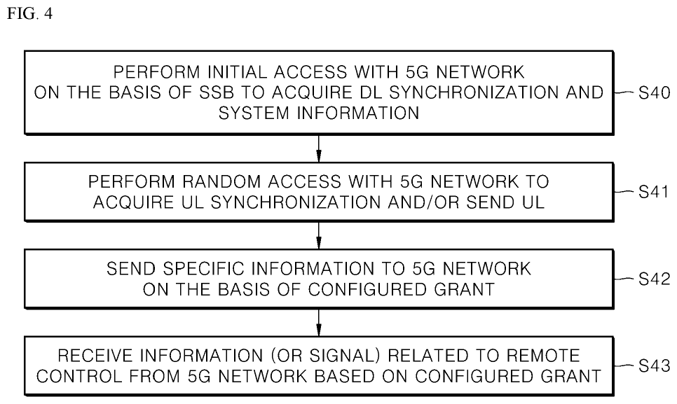

Referring to FIG. 4, a vehicle may perform an example initial access procedure with a 5G network based on an SSB so as to acquire DL synchronization and system information (S40).

The vehicle may perform a random access procedure with the 5G network so as to acquire UL synchronization and/or send UL (S41).

The vehicle may send specific information to the 5G network based on a configured grant (S42). In other words, the vehicle may also send the specific information to the 5G network based on the configured grant instead of a process in which the vehicle receives a UL grant from the 5G network.

The vehicle may receive information (or a signal) related to remote control from the 5G network based on the configured grant (S43).

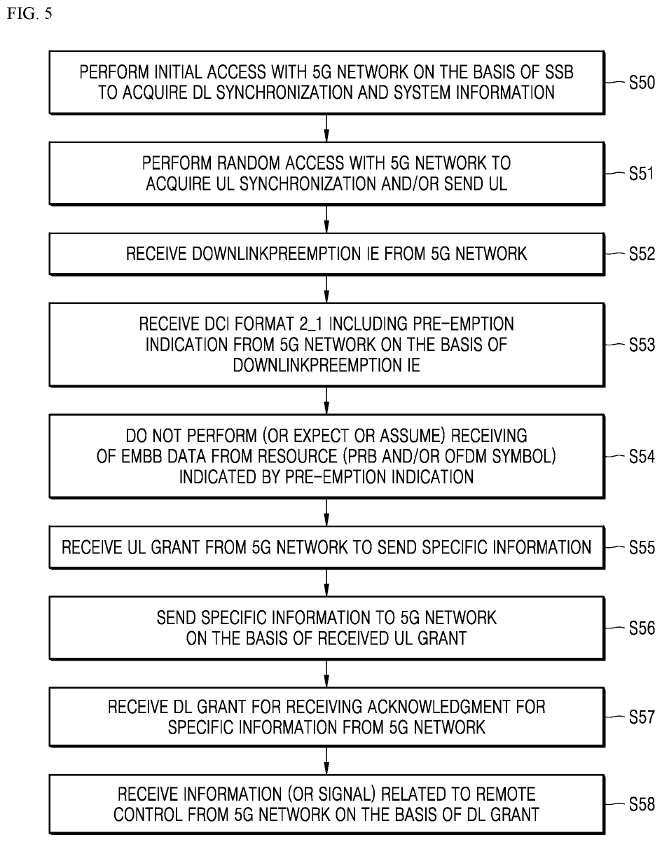

Referring to FIG. 5, a vehicle may perform an example initial access procedure with a 5G network based on an SSB so as to acquire DL synchronization and system information (S50).

The vehicle may perform a random access procedure with the 5G network so as to acquire UL synchronization and/or send UL (S51).

The vehicle may receive a DownlinkPreemption IE from the 5G network (S52).

The vehicle may receive a downlink control information (DCI) format 2_1 including pre-emption indication from the 5G network based on the DownlinkPreemption IE (S53).

The vehicle may not receive enhanced mobile broadband (eMBB) data from a resource (physical resource block (PRB) and/or an orthogonal frequency-division multiplexing (OFDM) symbol) indicated by the pre-emption indication (S54).

The vehicle may receive a UL grant from the 5G network so as to send specific information (S55).

The vehicle may send the specific information to the 5G network based on the UL grant (S56).

The vehicle may receive a DL grant for receiving an acknowledgment for the specific information from the 5G network (S57).

The vehicle may receive information (or a signal) related to remote control from the 5G network based on the DL grant (S58).

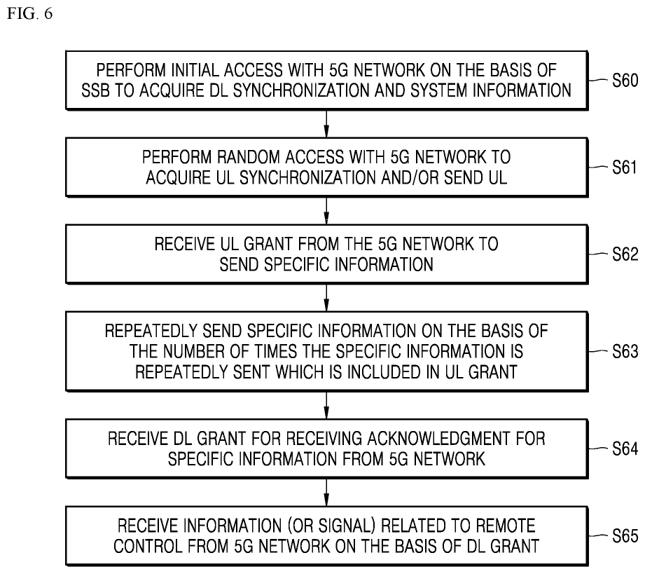

Referring to FIG. 6, a vehicle may perform an initial access procedure with a 5G network based on an SSB so as to acquire DL synchronization and system information (S60).

The vehicle may perform a random access procedure with the 5G network so as to acquire UL synchronization and/or send UL (S61).

The vehicle may receive a UL grant from the 5G network so as to send specific information (S62). The UL grant may include information about the number of times that the specific information is repeatedly sent.

The vehicle may repeatedly send the specific information based on the information about the number of times that the specific information is repeatedly sent (S63).

The repeatedly sending of the specific information is performed through frequency hopping, the first sending of the specific information may be performed through a first frequency resource, and the second sending of the specific information may be performed through a second frequency resource.

The specific information may be sent through a narrowband of 6 resource blocks (RBs) or 1 RB.

The vehicle may receive a DL grant for receiving an acknowledgment for the specific information from the 5G network (S64).

The vehicle may receive information (or a signal) related to remote control from the 5G network based on the DL grant (S65).

The above-described 5G communication technology may be applied to contents which will be described below and may supply realization or clarification of technical features of methods provided in the present specification.

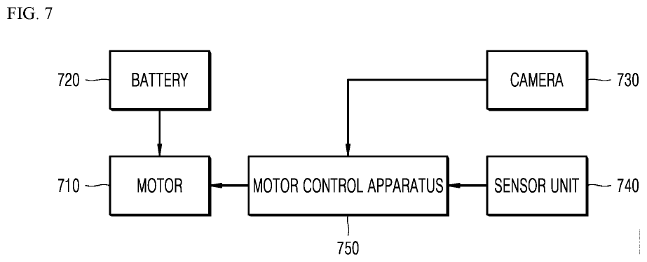

FIG. 7 is a schematic view illustrating an example configuration of an electric vehicle.

Referring to FIG. 7, an electric vehicle 700 may be a vehicle capable of autonomous driving and includes a motor 710, a battery 720, a camera 730, a sensor unit 740, and a motor control apparatus 750.

Hereinafter, a function of each of the components will be described in detail.

The motor 710 provides power for driving the electric vehicle 700.

The battery 720 stores electric power for driving the motor 710.

The camera 730 is attached to an outer side of the electric vehicle 700 and captures an image of an external environment of the electric vehicle 700. The camera 730 may be mounted on a front portion of the electric vehicle 700 or on a rear or side portion of the electric vehicle 700.

The sensor unit 740 may include at least one sensor and senses specific information about the external environment of the electric vehicle 700. As an example, the sensor unit 740 may include a rider sensor, a radar sensor, an infrared sensor, an ultrasonic sensor, a radio frequency (RF) sensor, or the like configured to measure a distance to an object (another vehicle, a person, a hill, or the like) positioned around the electric vehicle 700 and may include various other sensors such as a geomagnetic sensor, an inertial sensor, and a light sensor.

The motor control apparatus 750 is an apparatus included in the electric vehicle 700 and controls driving of the motor 710.

The electric vehicle 700 may drive with optimum energy efficiency, a minimum distance, or a minimum time duration by the control of the motor control apparatus 750. Particularly, the motor control apparatus 750 may generate driving-related information of the electric vehicle 700 and control the motor 710 using the generated driving-related information in the future to achieve optimum energy efficiency.

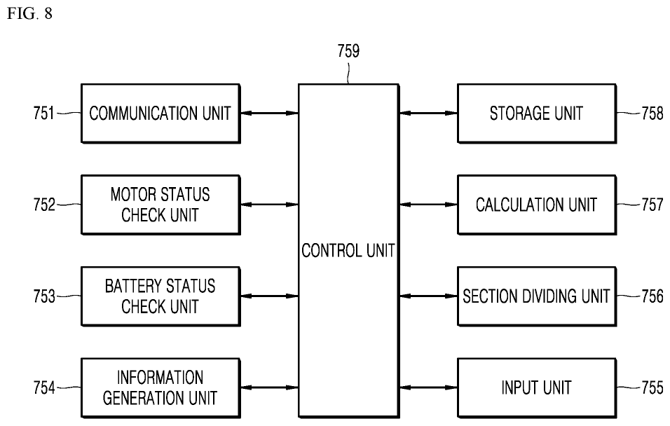

Hereinafter, the motor control apparatus 750 will be described in more detail with reference to FIG. 8.

FIG. 8 is a schematic view illustrating an example of the motor control apparatus 750.

Referring to FIG. 8, the motor control apparatus 750 may include a communication unit 751, a motor status check unit 752, a battery status check unit 753, an information generation unit 754, an input unit 755, a section dividing unit 756, a calculation unit 757, a storage unit 758, and a control unit 759.

Here, the information generation unit 754, the section dividing unit 756, the calculation unit 757, and the control unit 759 may be modules based on processors. Here, each of the processors may include one or more among a central processing unit, an application processor, and a communication processor.

Hereinafter, a function of each of the components will be described.

The communication unit 751 communicates with an external apparatus, such as an external cloud server and another vehicle, and other components in the electric vehicle 700. The communication unit 751 may perform a communication function using wired communication or wireless communication.

As an example, the communication unit 751 may include a mobile communication module, a short range communication module, and the like so as to perform wireless communication.

The mobile communication module transmits or receives a wireless signal to or from at least one among a base station, an external terminal device, and a communication server in a mobile communication network which is built for mobile communication according to technical standards or communication methods such as global system for mobile communication (GSM), code division multi access (CDMA), CDMA2000, enhanced voice-data optimized or enhanced voice-data only (EV-DO), wideband CDMA (WCDMA), high speed downlink packet access (HSDPA), high speed uplink packet access (HSUPA), long term evolution (LTE), or long term evolution-advanced (LTE-A).

The short range communication module is for short range communication and may be a module in which at least one technology is applied among Bluetooth, radio frequency identification (RFID), infrared data association (IrDA), ultra wideband (UWB), ZigBee, near field communication (NFC), Wi-Fi, Wi-Fi Direct, and wireless Universal Serial Bus (Wireless USB) technologies.

The motor status check unit 752 gathers status information of the motor 710.

The status information of the motor 710 may include voltage information, current information, and operating frequency information of the motor 710 in a case in which the electric vehicle 700 drives. To this end, the motor status check unit 752 may include sensors configured to measure a voltage, a current, and an operating frequency, such as a voltage sensor, a current sensor, and a frequency sensor.

In addition, the motor status check unit 752 may measure the voltage, the current, and the operating frequency of the motor 710 based on a motor status check instruction sent from the control unit 759.

The battery status check unit 753 gathers status information of the battery 720.

The status information of the battery 720 may include battery charging status information and usage information of the battery 720 in a specific time period. To this end, the battery status check unit 753 may include various sensors.

The information generation unit 754 may generate driving-related information based on an image captured by the camera 730, information sensed by the sensor unit 740, status information of the motor 710 gathered by the motor status check unit 752, and status information of the battery 720 gathered by the battery status check unit 753.

The driving-related information may include a road type (which will be described below) on which the electric vehicle 700 drives, a congestion level of the road type on which the electric vehicle 700 drives (that is, information of the number of vehicles on the road), speed information of the electric vehicle 700, status information of the motor 710, and usage information of the battery 720.

Meanwhile, the driving-related information may be stored in the storage unit 758 of the electric vehicle 700 or in a cloud server. In the case in which the driving-related information is stored in the cloud server, there is an advantage in that a large number of pieces of the driving-related information can be stored. In addition, in the case in which the driving-related information is stored in the cloud server, the communication unit 751 may send the generated driving-related information to the cloud server.

Hereinafter, for the sake of convenience of description, it is assumed that the driving-related information is stored in the cloud server. In this case, the communication unit 751 may send the driving-related information to the cloud server.

The input unit 755 receives an expected driving route from a user in a case in which the electric vehicle 700 drives. The expected driving route includes a departure location and an arrival location.

As an example, the input unit 755 may include a touch display, and the user may touch the touch display to send the expected driving route to the input unit 755.

The section dividing unit 756 divides the expected driving route into a plurality of sections. The section dividing unit 756 may divide the expected driving route into the plurality of sections based on navigation map information stored in the storage unit 758 and may divide the expected driving route into a plurality of sections using various information.

Here, each of the plurality of sections has one of two or more predefined road types.

According to some embodiments, each of the two or more road types may include a straight type, an S-shaped type, a right turn type, a left turn type, a U-turn type, and a T-shaped type.

More specifically, each of the two or more road types may include a straight flat type, a straight uphill type, a straight downhill type, an S-shaped flat type, an S-shaped uphill type, an S-shaped downhill type, a right turn flat type, a right turn uphill type, a right turn downhill type, a left turn flat type, a left turn uphill type, a left turn downhill type, a U-turn flat type, a U-turn uphill type, a U-turn downhill type, a T-shaped flat type, a T-shaped uphill type, and a T-shaped downhill type. Meanwhile, there may be various road types in addition to the above-described road types.

That is, the section dividing unit 756 may analyze what road types are in the expected driving route based on the navigation map information and may divide the expected driving route into the plurality of sections based on the analyzed road type.

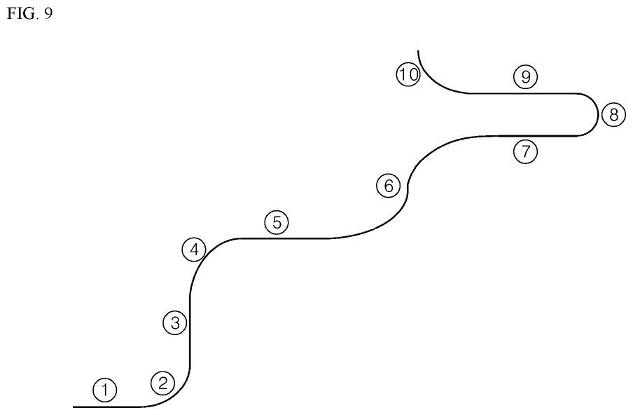

As an example, an example of the expected driving route is illustrated in FIG. 9.

Referring to FIG. 9, the section dividing unit 756 may divide the expected driving route into ten sections. Here, the ten sections may be divided into five straight type sections \textcircled{1}, \textcircled{3}, \textcircled{5}, \textcircled{7}, and \textcircled{9}, one left turn type section \textcircled{2}, two right turn type sections \textcircled{4} and \textcircled{10}, one S-shaped type section \textcircled{6}, and one U-turn type section \textcircled{8}.

The calculation unit 757 calculates a driving control value of the motor 710, that is, a motor control value, at each of the plurality of sections using pieces of past driving-related information of the electric vehicle 700 for each of the two or more road types. The past driving-related information is driving-related information which had been generated by the information generation unit 754 and stored at a past time point.

That is, the plurality of sections have specific road types, and the calculation unit 757 selects the past driving-related information about the road types corresponding to the plurality of sections among the pieces of the past driving-related information received from the cloud server. In addition, the calculation unit 757 may extract motor status information from the past driving-related information selected for each of the plurality of sections and calculate the extracted motor status information as the motor control values for the plurality of sections.

The control unit 759 controls the motor 710 of the electric vehicle 700 which drives the vehicle on the expected driving route based on the calculated motor control value. In addition, the control unit 759 may control at least another component in the motor control apparatus 750, perform calculation related to communication, or perform a data signal processing.

Hereinafter, an operation in which the motor control apparatus 750 generates and stores the driving-related information and controls the motor of the electric vehicle 700 at the present time point will be described in detail with reference to the following drawings.

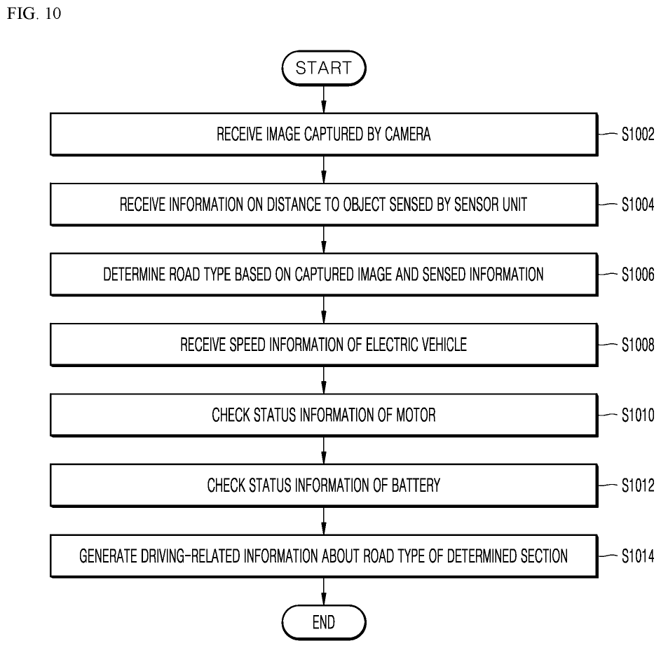

FIG. 10 is a flowchart for describing an example method of generating driving-related information.

Here, the electric vehicle 700 is driving on a specific route set by a user, and driving-related information is generated whenever the electric vehicle 700 drives on the specific route. In addition, it is assumed that a position of the electric vehicle 700 is detected in the specific route.

Hereinafter, a process in which operations are sequentially performed will be described.

In operation S1002, an image captured by the camera 730 is received through the communication unit 751. Here, the image may be an image of a place adjacent to the electric vehicle 700.

In operation S1004, information in a distance to an object sensed by the sensor unit 740 is received through the communication unit 751. Here, the object is at a position adjacent to the electric vehicle 700 and may be another vehicle or a hill adjacent to a road.

In operation S1006, the information generation unit 754 determines a road type of a section in which the electric vehicle 700 is driving on based on the captured image and the sensed information. Meanwhile, the information generation unit 754 may determine the road type of the section in which the electric vehicle 700 is driving on by further using navigation map information stored in the storage unit 758.

Here, the determined road type may be one among a straight flat type, a straight uphill type, a straight downhill type, an S-shaped flat type, an S-shaped uphill type, an S-shaped downhill type, a right turn flat type, a right turn uphill type, a right turn downhill type, a left turn flat type, a left turn uphill type, a left turn downhill type, a U-turn flat type, a U-turn uphill type, a U-turn downhill type, a T-shaped flat type, a T-shaped uphill type, and a T-shaped downhill type.

Meanwhile, a congestion level may be further determined based on the captured image and the sensed information.

In operation S1008, speed information of the electric vehicle 700 is checked and received through the communication unit 751.

In operation S1010, the motor status check unit 752 checks status information of the motor 710 which is running. The motor status information may include voltage information, current information, and operating frequency information of the motor 710.

In operation S1012, the battery status check unit 753 checks status information of the battery 720. The battery status information may include charging status information of a battery, usage information of the battery used in a specific time period, and the like.

In operation S1014, the information generation unit 754 generates driving-related information about the road type of the determined section.

According to some embodiments, the driving-related information may include a road type on which the electric vehicle 700 is driving, a road congestion level of the road type on which the electric vehicle 700 is driving, speed information of the electric vehicle 700, status information of the motor 710, and usage information of the battery 720. The status information of the motor 710 may include voltage information, current information, and operating frequency information of the motor 710.

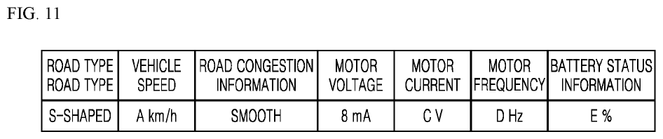

FIG. 11 is a table illustrating an example of driving-related information.

Meanwhile, the above-described operations of FIG. 10 may be repeatedly performed. Accordingly, various pieces of driving-related information of two or more road sections may be stored.

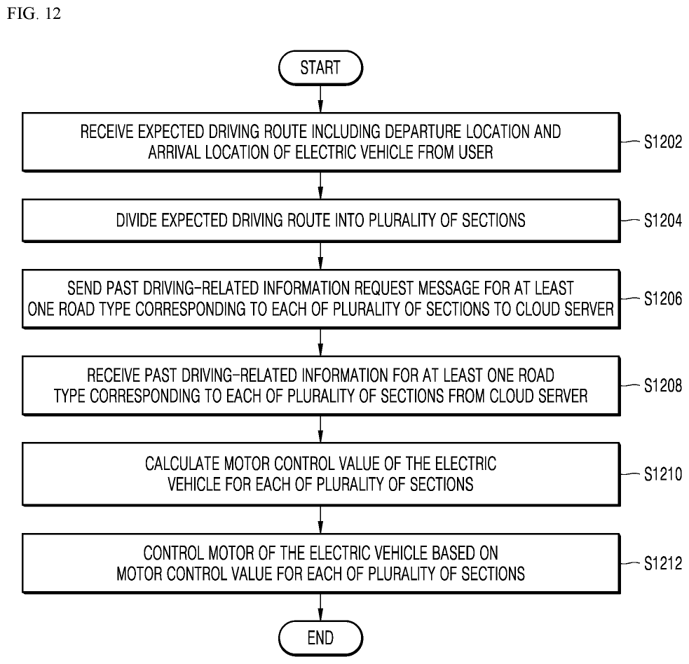

FIG. 12 is a flowchart for describing an example method of controlling the motor 710 of the electric vehicle 700.

Here, past driving-related information is information which had been generated by the electric vehicle 700 at a past time point, and it is assumed that the past driving-related information is stored in the cloud server and is received by the cloud server through the communication unit 751 for the sake of convenience of description.

Hereinafter, a process in which operations are sequentially performed will be described.

In operation S1202, the input unit 755 receives an expected driving route, which includes a departure location and an arrival location, of the electric vehicle from a user. As an example, the input unit 755 includes a touch display and receives the expected driving route through the touch display.

In operation S1204, the section dividing unit 756 divides the expected driving route into a plurality of sections. Here, each of the plurality of sections has one of two or more road types.

The section dividing unit 756 may analyze road types of the expected driving route based on navigation map information and the like, and divide the expected driving route into the plurality of sections based on the analyzed road types.

In operation S1206, the communication unit 751 sends a past driving-related information request message for at least one road type corresponding to each of the plurality of sections to the cloud server.

In operation S1208, the communication unit 751 receives the past driving-related information for the at least one road type corresponding to each of the plurality of sections from the cloud server.

In operation S1210, the calculation unit 757 calculates a motor control value of the electric vehicle 700 for each of the plurality of sections using the past driving-related information about at least one road type of each of the plurality of sections.

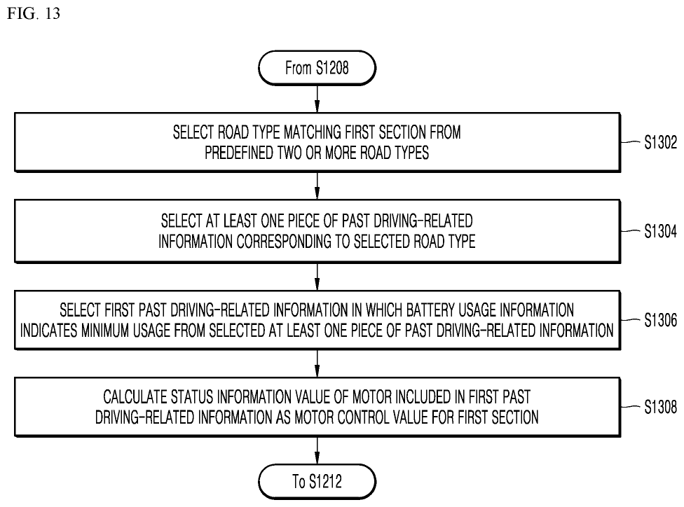

FIG. 13 is a detailed flowchart for describing the operation S1210.

FIG. 13 is the flowchart for describing that an example motor control value of the electric vehicle 700 is calculated in a first section which is one section among the plurality of sections included in the expected driving route. Meanwhile, the description given with reference to FIG. 13 may be applied to the plurality of sections included in the expected driving route.

In operation S1302, the calculation unit 757 selects a road type, which matches to the first section, from two or more predefined road types. The operation S1302 may be performed based on the navigation map information and the like.

As an example, the calculation unit 757 determines whether the first section has a straight type, an S-shaped type, a right turn type, a left turn type, a U-turn type, or a T-shaped type.

In operation S1304, the calculation unit 757 selects at least one piece of past driving-related information corresponding to the selected road type among the past driving-related information about the at least one road type received from the cloud server.

As an example, in a case in which the at least one road type is a straight type, an S-shaped type, a right turn type, or a left turn type, and the selected road type is the right turn type, the calculation unit 757 selects at least one piece of the past driving-related information related to the right turn type.

In operation S1306, the calculation unit 757 selects first past driving-related information in which battery usage information indicates minimum usage from the selected at least one piece of the past driving-related information.

More specifically, the number of pieces of the past driving-related information about each of the road types may be one or more, and the past driving-related information may include a road type, road congestion information of the road type on which the electric vehicle 700 was driving on, speed information of the electric vehicle 700, status information of the motor 710, and usage information of the battery 720. In addition, one or more pieces of the past driving-related information may be different from each other.

In addition, the calculation unit 757 selects the first past driving-related information in which the usage information of the battery 720 indicates minimum usage, from one or more pieces of the past driving-related information of the road type which is the same as that of the first section.

As an example, in a case in which there are three pieces of the past driving-related information, the calculation unit 757 selects first past driving-related information, in which the usage information of the battery 720 indicates minimum usage, from the three pieces of past driving-related information.

In operation S1308, the calculation unit 757 calculates a status information value of the motor, which is included in the first past driving-related information, as a motor control value for the first section.

Accordingly, the calculation unit 757 may select the past driving-related information having optimum energy efficiency in the first section.

Referring to FIG. 12 again, in operation S1212, the control unit 759 controls the motor 710 of the electric vehicle 700 which will drive the expected driving route based on the motor control value of the electric vehicle 700 for each of the plurality of sections.

In short, the present disclosure divides a driving route into a plurality of sections and controls the motor 710 for each of the divided plurality of sections so as to increase energy efficiency of the electric vehicle 700 which drives autonomously. Here, each of the plurality of sections has one road type of two or more predefined road types.

In addition, the present disclosure calculates a driving control value of the motor 710 for each of the plurality of sections, and the calculated driving control value is a driving control value of the motor 710 at a past time point at which the electric vehicle 700 drove most efficiently in a section having a road type which was the same as that of the corresponding section. That is, the driving control value of the motor 710 in the corresponding section is a status information value of the motor 710 when a use amount of the battery 720 was a minimum in the past time point.

Accordingly, in a case in which the motor control apparatus 750 controls the motor 710 of the electric vehicle 700, the electric vehicle 700 can drive with optimum energy efficiency in an entire expected driving route including a plurality of sections.

Meanwhile, according to the above description, it has been described that the electric vehicle 700 calculates a control value for controlling driving of the motor 710 using past driving-related information of the electric vehicle 700, but according to another embodiment, an electric vehicle 700 may calculate a control value for controlling driving of a motor 710 using both of past driving-related information of the electric vehicle 700 and past driving-related information of another electric vehicle. Here, another electric vehicle may be a vehicle having the same type as the electric vehicle 700.

More specifically, the cloud server receives past driving-related information from at least one electric vehicle which is different from the electric vehicle 700, and the past driving-related information is divided according to road types and stored. In addition, in a case in which the cloud server receives a past driving-related information request message for a specific section from the electric vehicle 700, the cloud server sends past driving-related information of the specific section which received from the electric vehicle 700 and another electric vehicle. The motor control apparatus 750 controls the motor 710 using the past driving-related information of the specific section.

Meanwhile, a status may occur in which a congestion level of an expected driving route is different from a congestion level of an actual road. In this case, the calculation unit 757 may reselect past driving-related information corresponding to the congestion level of the actual road.

More specifically, a case may occur in which the electric vehicle 700 drives an expected driving route, and a road congestion level which is checked at a time point at which the electric vehicle 700 enters a first section of the expected driving route is different from a road congestion level included in first past driving-related information used in the first section. As an example, the road congestion level included in the first past driving-related information is “smooth,” and the checked road congestion level may be “congested.”

In this case, the calculation unit 757 changes the past driving-related information needed for driving control of the motor 710. That is, in the case in which the checked road congestion level is different from the road congestion level included in the first past driving-related information, the calculation unit 757 may select second past driving-related information including road congestion information corresponding to the road congestion level from among at least one past driving-related information received from the cloud server and calculate a status information value of the motor, which is included in the second past driving-related information, as a motor control value for the first section. Particularly, in a case in which the number of pieces of the road congestion information corresponding to the checked road congestion level is two or more, the second past driving-related information may be past driving-related information in which usage information of the battery 720 indicates minimum usage.

In addition, although it has been described that all components included in the embodiments of the present disclosure are coupled to be one component, or linked to operate as one coupled component, the present disclosure is not necessarily limited to the embodiments, and one or more components of all the components may also be selectively coupled to operate. In addition, although each of the components may be formed as one separate hardware device, the present disclosure may also be realized as a computer program including program modules which perform some or an entirety of functions of one or a plurality of hardware devices in which some or an entirety of the components are selectively combined. Codes and code segments included in the computer program may be easily inferred by those skilled in the art. The computer program may be stored in a computer readable media and read therefrom and executed by a computer so that the embodiments of the present disclosure can be realized. The computer readable media for storing the computer program includes a storage medium such as a magnetic recording medium, an optical recording medium, and a semiconductor recording element. In addition, the computer program realizing the embodiments of the present disclosure includes program modules sent through an external apparatus in real time.

According to the present disclosure, there is an advantage in that energy efficiency of an electric vehicle can be improved by precisely controlling a motor.

In addition, an autonomous driving route can be provided according to a user's selection.

In addition, the effects of the present disclosure are not limited to the above-described effects, and it should be understood that the effects will include any effect which can be inferred from configurations described in the detailed description and the claims.

Although the present disclosure has been described with reference to the embodiments, various changes or modifications may be made by those skilled in the art. Accordingly, it may be understood that such changes and modifications may fall within the scope of the present disclosure as long as not departing from the spirit and scope of the present disclosure.

What is claimed is:

1. A motor control apparatus, comprising:
an input unit configured to receive a driving route including a departure location and an arrival location for an electric vehicle;
a section dividing unit configured to divide the driving route into a plurality of sections wherein each of the plurality of sections has one of two or more predefined road types;
a calculation unit configured to calculate a motor control value of the electric vehicle for each of the plurality of sections using past driving-related information of the electric vehicle for the two or more predefined road types; and
a control unit configured to, during travel on the driving route, control a motor of the electric vehicle based on the calculated motor control value for each of the plurality of sections.

2. The motor control apparatus of claim 1, wherein the two or more predefined road types comprise a straight flat type, a straight uphill type, a straight downhill type, an S-shaped flat type, an S-shaped uphill type, an S-shaped downhill type, a right turn flat type, a right turn uphill type, a right turn downhill type, a left turn flat type, a left turn uphill type, a left turn downhill type, a U-turn flat type, a U-turn uphill type, a U-turn downhill type, a T-shaped flat type, a T-shaped uphill type, and a T-shaped downhill type.

3. The motor control apparatus of claim 1, wherein the past driving-related information comprises a driving road type, road congestion information corresponding to the driving road type, speed information of the electric vehicle, status information of the motor, and usage information of a battery.

4. The motor control apparatus of claim 3, wherein the status information of the motor comprises voltage information, current information, and operating frequency information of the motor.

5. The motor control apparatus of claim 1, further comprising:
a motor status check unit configured to check status information of the motor;
a battery status check unit configured to check status information of the battery; and
an information generation unit configured to generate the past driving-related information based on an image captured by a camera of the electric vehicle, information sensed by a sensor unit of the electric vehicle, the status information of the motor, and the status information of the battery.

6. The motor control apparatus of claim 3, wherein the calculation unit calculates the motor control value for a first section among the plurality of sections by performing operations comprising:
selecting a road type which matches the first section of the two or more predefined road types;
selecting at least one piece of the past driving-related information corresponding to the selected road type;
selecting a first piece of the past driving-related information in which the usage information of the battery indicates minimum usage among the past driving-related information; and
calculating a status information of the motor, which is included in the first piece of the past driving-related information, as the motor control value for the first section.

7. The motor control apparatus of claim 6, wherein, when a road congestion level measured at a time point at which the electric vehicle enters the first section is different from a road congestion level included in the first piece of the past driving-related information, the calculation unit is configured to select a second piece of the past driving-related information including road congestion information corresponding to the measured road congestion level and calculate a status information of the motor, which is included in the second piece of the past driving-related information, as the motor control value for the first section.

8. The motor control apparatus of claim 1, further comprising:
a communication unit configured to receive the past driving-related information of the electric vehicle from an external server,
wherein the past driving-related information of the electric vehicle are stored in the external server.

9. A motor control apparatus of claim 1, further comprising:
a communication unit configured to receive past driving-related information of another electric vehicle having the same road types as the electric vehicle for each of the two or more road types from an external server.

10. The motor control apparatus of claim 1, wherein the control unit is further configured to control at least one other component of the motor control apparatus to perform a calculation that relates to communication or data signal processing.

11. A method of controlling a motor, comprising:
receiving, by an input unit, an driving route including a departure location and an arrival location for an electric vehicle;
dividing, by a section dividing unit, the driving route into a plurality of sections wherein each of the plurality of sections includes one of two or more predefined road types;
calculating, by a calculation unit, a motor control value of the electric vehicle for each of the plurality of sections using past driving-related information of the electric vehicle for the two or more predefined road types; and
controlling, by a control unit, during travel on the driving route, a motor of the electric vehicle based on the calculated motor control value for each of the plurality of sections.

12. The method of claim 11, wherein the two or more predefined road types comprise a straight flat type, a straight uphill type, a straight downhill type, an S-shaped flat type, an S-shaped uphill type, an S-shaped downhill type, a right turn flat type, a right turn uphill type, a right turn downhill type, a left turn flat type, a left turn uphill type, a left turn downhill type, a U-turn flat type, a U-turn uphill type, a U-turn downhill type, a T-shaped flat type, a T-shaped uphill type, and a T-shaped downhill type.

13. The method of claim 11, wherein the past driving-related information comprises a driving road type, road congestion information corresponding to the driving road type, speed information of the electric vehicle, status information of the motor, and usage information of a battery.

14. The method of claim 13, wherein the status information of the motor comprises voltage information, current information, and operating frequency information of the motor.

15. The method of claim 11, further comprising:
checking, by a motor status check unit, status information of the motor;
checking, by a battery status check unit, status information of the battery; and
generating, by an information generation unit, the past driving-related information based on an image captured by a camera of the electric vehicle, information sensed by a sensor unit of the electric vehicle, the status information of the motor, and the status information of the battery.

16. The method of claim 13, wherein calculating the motor control value for a first section among the plurality of sections comprising:
selecting a road type which matches the first section among the two or more predefined road types;
selecting at least one piece of the past driving-related information corresponding to the selected road type;
selecting a first piece of the past driving-related information in which the usage information of the battery indicates minimum usage among the past driving-related information; and
calculating a status information of the motor, which is included in the first piece of the past driving-related information, as the motor control value for the first section.

17. The method of claim 16, wherein, when a road congestion level measured at a time point at which the electric vehicle enters the first section is different from a road congestion level included in the first piece of the past driving-related information, calculating the motor control value for a first section among the plurality of sections further comprising:
selecting, by the calculation unit, a second piece of the past driving-related information including road congestion information corresponding to the measured road congestion level and calculates a status information of the motor, which is included in the second piece of the past driving-related information, as the motor control value for the first section.

18. The method of claim 11, further comprising:
receiving, by a communication unit, the past driving-related information of the electric vehicle from the external server,
wherein the past driving-related information of the electric vehicle are stored in the external server.

19. The method of claim 11, further comprising:
receiving, by a communication unit, past driving-related information of another electric vehicle having the same road types as the electric vehicle for each of the two or more road types from an external server.

20. The method of claim 11, further comprising:
controlling, by the control unit, at least one other component of the electric vehicle, to perform a calculation that relates to communication or data signal processing.
